(19) United States
(12) Patent Application Publication
(10) Pub. No.: US 2026/0052335 A1
(43) Pub. Date: Feb. 19, 2026

(54) HIGH-FREQUENCY SPEAKER FOR EARPHONES

(71) Applicant: ALMUS Corp., Chungcheongnam-do (KR)

(72) Inventors: Jong Won LEE, Incheon (KR); Yun Uk HA, Incheon (KR); Jeong Kwon PARK, Gyeonggi-do (KR); Seung Ki KIM, Incheon (KR); Soon Hyuk HONG, Gyeonggi-do (KR)

(21) Appl. No.: 19/293,272

(22) Filed: Aug. 7, 2025

(30) Foreign Application Priority Data
Aug. 19, 2024 (KR) 10-2024-0110277

(51) Int. Cl. H04R 1/10; H04R 7/04

(52) U.S. Cl. CPC H04R 1/1058; H04R 7/04

(57) ABSTRACT

Provided is a high-frequency speaker for earphones, including: a speaker housing; a high-frequency yoke disposed in a lower part of the speaker housing; a ventilation membrane disposed beneath the high-frequency yoke to adjust an amount of air ventilation; an inner magnet disposed above a central portion of the high-frequency yoke; an outer magnet disposed above the high-frequency yoke and disposed outside the inner magnet; a high-frequency coil having a plate-shaped ring structure and disposed above the inner magnet and the outer magnet to extend over the inner magnet and the outer magnet; a flexible substrate disposed outside the high-frequency coil and providing an electric signal to the high-frequency coil; and a high-frequency diaphragm disposed above the high-frequency coil and outputting high-frequency sound.

### CROSS-REFERENCE TO RELATED APPLICATION

This application claims priority to and the benefit of Korean Patent Application No. 10-2024-0110277 filed on Aug. 19, 2024, the disclosure of which is incorporated herein by reference in its entirety.

### TECHNICAL FIELD

The present disclosure relates to earphones, and more particularly, to a high-frequency speaker for earphones.

### BACKGROUND

The earphones include speaker units within housings that generate sound waves.

A speaker unit may include a diaphragm, a magnet, a coil, and a plate. When current is applied to the coil, the coil becomes magnetic, and the electrical interaction between the coil and the plate causes the coil to move, causing the diaphragm to move. Such a speaker unit include a low-frequency speaker that reproduces bass sounds and a high-frequency speaker that reproduces treble sounds.

However, in the case of conventional high-frequency speakers, the high-frequency coil has a cylindrical structure, which results in an increase in the overall size of the high-frequency speaker. In addition, because the flexible substrate electrically connected to the high-frequency coil is disposed outside the high-frequency diaphragm, the size of the diaphragm is inevitably limited, leading to constraints in reproducing high-frequency sounds.

### SUMMARY

The present disclosure provides a high-frequency speaker for earphones, in which the structure of a high-frequency coil in the high-frequency speaker is configured as a plate-shaped ring structure and a flexible substrate is disposed outside the high-frequency coil.

The objects of the present disclosure are not limited to the aforementioned object, and other objects not mentioned may be clearly understood by those skilled in the art from the description below.

In one aspect of the present disclosure, there is provided a high-frequency speaker for earphones, including: a speaker housing; a high-frequency yoke disposed in a lower part of the speaker housing; a ventilation membrane disposed beneath the high-frequency yoke to adjust an amount of air ventilation; an inner magnet disposed above a central portion of the high-frequency yoke; an outer magnet disposed above the high-frequency yoke and disposed outside the inner magnet; a high-frequency coil having a plate-shaped ring structure and disposed above the inner magnet and the outer magnet to extend over the inner magnet and the outer magnet; a flexible substrate disposed outside the high-frequency coil and providing an electric signal to the high-frequency coil; and a high-frequency diaphragm disposed above the high-frequency coil and outputting high-frequency sound.

An outer surface of the inner magnet may be in close contact with a side surface of an outer magnet hole formed in the outer magnet, and the inner magnet and the outer magnet are arranged to have opposite polarities.

The high-frequency coil may be in the form of a plate-shaped ring structure that is wider in a horizontal direction than in a vertical direction and is formed by winding a line conductor.

The high-frequency coil may be attached to the high-frequency diaphragm and is spaced apart above the inner magnet and the outer magnet.

### BRIEF DESCRIPTION OF THE DRAWINGS

FIG. 1 is an exploded view of a high-frequency speaker for earphones according to the present disclosure.

FIG. 2A is a cross-sectional side view of the high-frequency speaker illustrated in FIG. 1.

FIG. 2B is a cross-sectional view of the high-frequency speaker illustrated in FIG. 1.

FIG. 3 is a cross-sectional view showing a state in which an inner magnet and an outer magnet are in contact.

FIG. 4 is a graph explaining the change in the magnitude of the magnetic force depending on a separation distance between inner and outer magnets.

FIG. 5A is a reference diagram showing a winding-type high-frequency coil.

FIG. 5B is a reference diagram showing various shapes of a winding-type high-frequency coil.

### DETAILED DESCRIPTION

Hereinafter, embodiments of the present disclosure will be described in detail with reference to the accompanying drawings. In the following description and the accompanying drawings, substantially identical components are denoted by the same reference numerals, and redundant descriptions will be omitted. In addition, in describing the present disclosure, if it is determined that a detailed description of known functions or configurations may unnecessarily obscure the essence of the present disclosure, such detailed descriptions will be omitted.

Earphones according to embodiments of the present disclosure are provided with at least one microphone for picking up external noise for active noise cancellation (ANC). While the earphones according to embodiments of the present disclosure are wireless, the present disclosure may also be applied to wired earphones.

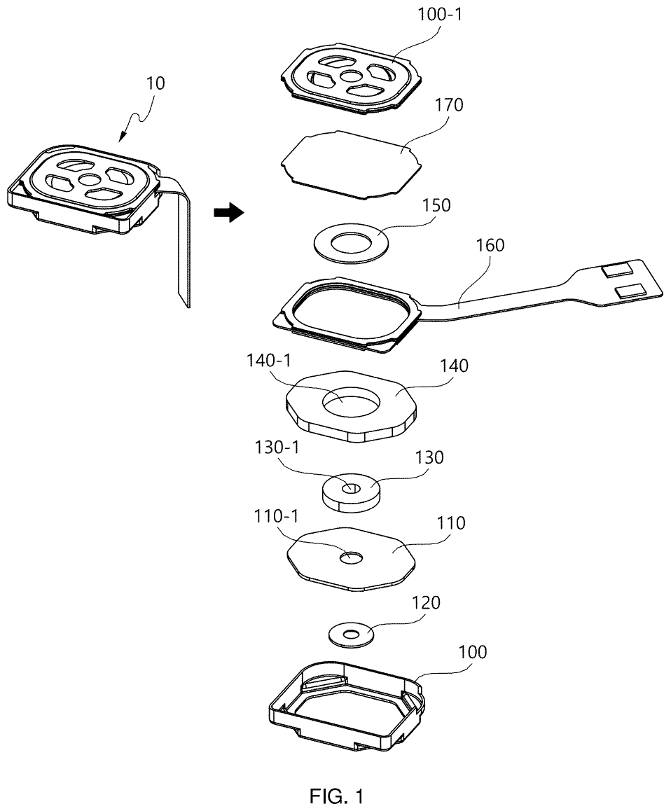

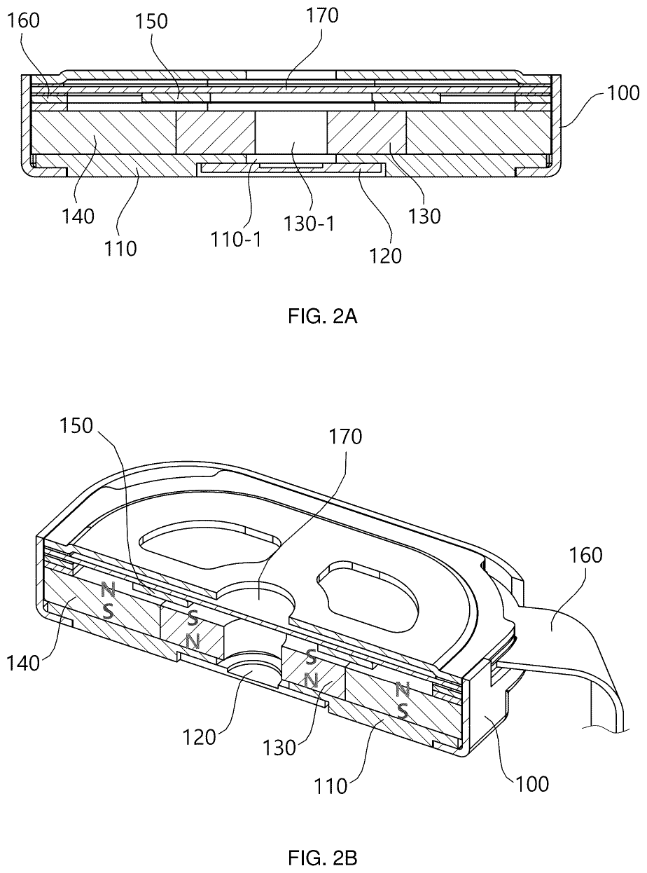

FIG. 1 is an exploded view of a high-frequency speaker 10 for earphones according to the present disclosure, FIG. 2A is a cross-sectional side view of the high-frequency speaker 10 illustrated in FIG. 1, and FIG. 2B is a perspective cross-sectional view of the high-frequency speaker 10 illustrated in FIG. 1.

The high-frequency speaker 10 according to the embodiments of FIGS. 1, 2A, and 2B may include a speaker housing 100, a high-frequency yoke 110, a ventilation membrane 120, an inner magnet 130, an outer magnet 140, a high-frequency coil 150, a flexible substrate 160, and a high-frequency diaphragm 170.

The speaker housing 100 may be provided with a cylindrical structure including an internal accommodation space for receiving each of the aforementioned components of the high-frequency speaker 10. That is, the speaker housing 100 may receive the high-frequency yoke 110, the ventilation membrane 120, the inner magnet 130, the outer magnet 140, the high-frequency coil 150, the flexible substrate 160, and the high-frequency diaphragm 170 in the internal accommodation space of the cylindrical structure. This cylindrical structures may include a cylindrical structure, a cuboid structure, and the like.

The speaker housing 100 may include a grille 100-1 for protecting each component received in the internal receiving space of the cylindrical structure. The grille 100-1 protects the high-frequency yoke 110, the ventilation membrane 120, the inner magnet 130, the outer magnet 140, the high-frequency coil 150, the flexible substrate 160, and the high-frequency diaphragm 170 received in the speaker housing 100 from the outside, and functions as a passage for emitting sound output from the high-frequency diaphragm 170 to the outside.

The high-frequency yoke 110 is disposed in a lower part of the speaker housing 100. The high-frequency yoke 110 has a ring-shaped plate structure. The ring-shaped plate structure may be a disc-shaped plate structure or a polygonal structure (such as a square or hexagonal shape).

The high-frequency yoke 110 may have a yoke hole 110-1 formed at a center of the ring-shaped plate structure. The yoke hole 110-1 refers to a hollow space at the center of the high-frequency yoke 110 to allow air to pass through. The periphery of the yoke hole 110-1 is formed with steps to provide a space in which the ventilation membrane 120 are to be placed.

The ventilation membrane 120 is a membrane disposed beneath the high-frequency yoke 110 to adjust an amount of air ventilation. The ventilation membrane 120 is placed at a position corresponding to the yoke hole 110-1 formed in the center of the high-frequency yoke 110. In order for the ventilation membrane 120 to be placed at a position corresponding to the yoke hole 110-1, a step may be formed around the periphery of the yoke hole 110-1, and the ventilation membrane 120 may be disposed at the periphery of the yoke hole 110-1 where the step is formed.

The inner magnet 130 is disposed above a central portion of the high-frequency yoke 110. Such an inner magnet 130 is an ring-shaped magnetic body having a predetermined thickness or greater and an inner magnet hole 130-1 formed with a hollow central portion. The ring-shaped magnet may have a circular structure or a polygonal structure (square, hexagon, and the like). This inner magnet 130 interacts electromagnetically with the high-frequency coil 150. That is, the inner magnet 130 forms a magnetic field with the outer magnet 140 and the high-frequency coil 150.

The inner magnet hole 130-1 is a hole formed to allow air flowing in through the ventilation membrane 120 to pass through.

The outer magnet 140 is disposed above a periphery of the high-frequency yoke 110. This outer magnet 140 is a ring-shaped magnetic body having an outer magnet hole 140-1 formed with a hollow central portion. The ring-shaped magnet may have a circular structure or a polygonal structure (square, hexagon, and the like.). A thickness of the outer magnet 140 may be the same as the thickness of the inner magnet 130.

The inner magnet 130 is inserted into the outer magnet hole 140-1 of the outer magnet 140. To this end, the outer magnet hole 140-1 may be the same shape as that of an outer circumferential surface of the inner magnet 130.

The inner magnet 130 and the outer magnet 140 are arranged to have opposite polarities.

Referring to FIG. 2B, it can be seen that the inner magnet 130 and the outer magnet 140 are arranged so that the N and S poles of the inner magnet 130 are disposed opposite to the S and N poles of the outer magnet 140, respectively.

By arranging the inner magnet 130 and the outer magnet 140 to have opposite polarities, electromagnetic interaction occurs between the inner magnet 130, the outer magnet 140, and the high-frequency coil 150.

An outer surface of the inner magnet 130 is in close contact with a side surface of the outer magnet hole 140-1 of the outer magnet 140.

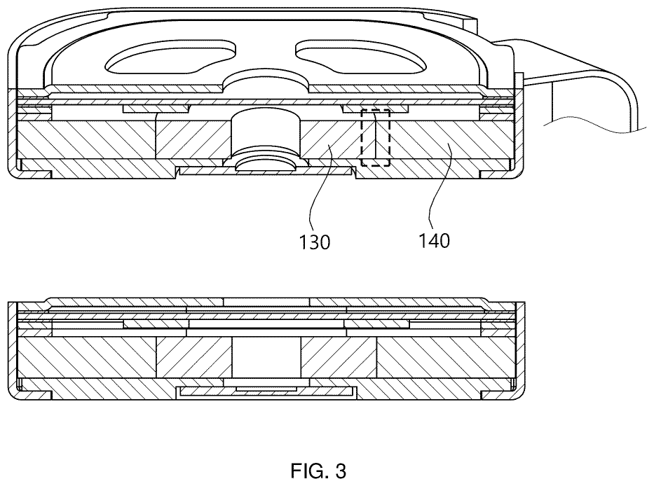

FIG. 3 is a cross-sectional view showing a state in which the inner magnet 130 and the outer magnet 140 are in contact with each other.

Referring to FIG. 3, it can be seen that the inner magnet 130 and the outer magnet 140 are in contact with each other (as indicated by a dotted line).

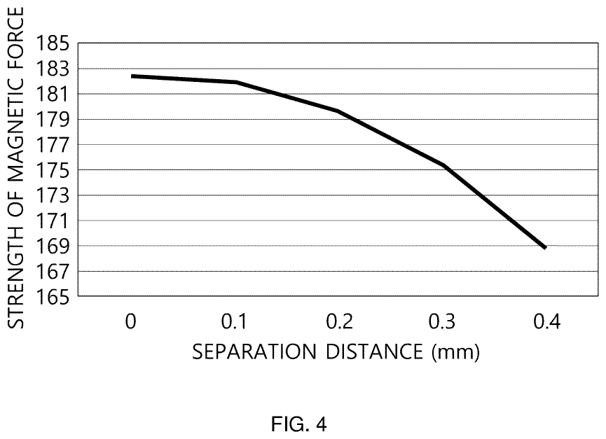

FIG. 4 is a graph explaining the change in the magnitude of the magnetic force depending on a separation distance between the inner magnet 130 and the outer magnet 140.

Referring to FIG. 4, it can be seen that the closer the distance between the inner magnet 130 and the outer magnet 140 is to zero, the strength of the magnetic force increases.

In the present disclosure, because the inner magnet 130 and the outer magnet 140 are in contact without any gap, the volume of the magnets may be maximized. In addition, because a contact area between the magnets increases, a density of magnetic flux lines acting on the high-frequency coil 150 may be improved, thereby increasing the speaker driving power.

Meanwhile, the inner magnet 130 and the outer magnet 140 may have the same vertical thickness or different vertical thicknesses. For example, the vertical thickness of the inner magnet 130 may be greater than the vertical thickness of the outer magnet 140. Accordingly, if the vertical thickness of the inner magnet 130 increases, a gap between the inner magnet 130 and the high-frequency coil 150 may be minimized, thereby increasing the magnetic force.

The high-frequency coil 150 is a coil that performs electromagnetic interaction between the inner magnet 130 and the outer magnet 140.

The high-frequency coil 150 is disposed above the inner magnet 130 and the outer magnet 140. In this case, the high-frequency coil 150 is spaced apart above the inner magnet 130 and the outer magnet 140. In addition, the upper part of the high-frequency coil 150 may be attached to a lower part of the high-frequency diaphragm 150.

The high-frequency coil 150 is configured as a coil having a plate-shaped ring structure, and includes a disc-shaped ring coil, a polygonal ring coil, and the like.

An upper surface of the high-frequency coil 150 having a plate-shaped ring structure is joined the high-frequency diaphragm 170, and a lower surface of the high-frequency coil 150 is maintained to be spaced apart above the inner magnet 130 and the outer magnet 140.

The high-frequency diaphragm 170 moves by the electromagnetic interaction of the high-frequency coil 150. That is, when current is applied to the high-frequency coil 150 and the high-frequency coil 150 becomes magnetized, the high-frequency diaphragm 170 joined the high-frequency coil 150 moves according to the magnetic polarity of the high-frequency coil 150.

The high-frequency coil 150 may be a winding-type high-frequency coil 150. That is, the high-frequency coil 150 may be a line conductor wound in a ring shape.

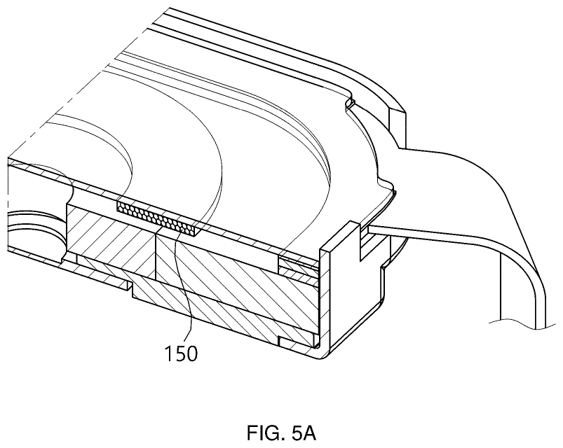

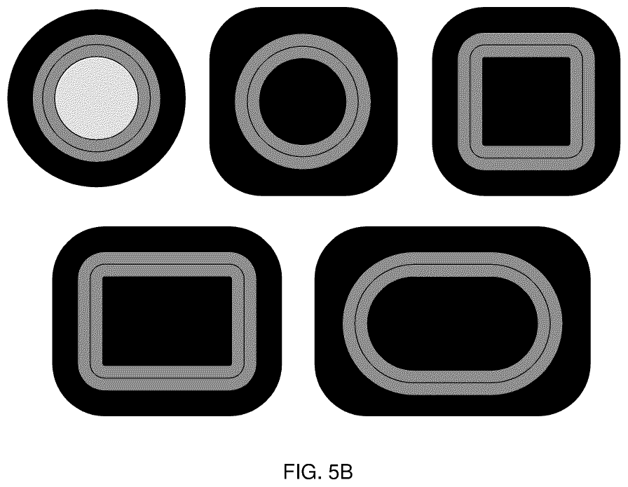

FIG. 5A is a reference drawing showing the winding-type high-frequency coil 150, and FIG. 5B is a reference drawing an exemplary shape of the winding-type high-frequency coil 150.

Referring to FIG. 5A, the winding-type high-frequency coil 150 may be disposed above the inner magnet 130 and the outer magnet 140, and more specifically, above a contact area between the inner magnet 130 and the outer magnet 140. In addition, the upper surface of the high-frequency coil 150 is coupled to the high-frequency diaphragm 170.

In the case of conventional high-frequency speakers, since the vertical cylindrical coil is located between the magnets, the upper plate must be disposed above the magnets, and because the coil between the magnets requires a certain height for speaker operation, there is a limit to reducing the overall height of the speaker. In comparison, the high-frequency coil 150 of the high-frequency speaker of the present disclosure includes a horizontal plate-shaped structure, and since the high-frequency coil is disposed above the magnets, a separate plate is not required to be disposed above the magnets, and the heights of the magnets may be reduced, thereby reducing the overall height of the speaker.

The high-frequency coil 150 refers to a plate-shaped coil that is wider in the horizontal direction than in the vertical direction and is formed by winding a wire-shaped conductor, such as copper or aluminum, from the inside to the outside or from the outside to the inside to conduct an electrical signal.

Referring to FIG. 5B, the planar shape of the high-frequency coil 150 may be circular, square, rectangular, or a shape in which two sides are straight and two sides are rounded, and the like.

On the outside of the high-frequency coil 150, a flexible substrate 160 is provided for providing an electric signal to the high-frequency coil 150. A central portion of the flexible substrate 160 may be in the shape of a hollow ring, and the high-frequency coil 150 may be disposed in the central portion. The flexible substrate 160 may be formed of a flexible material.

The flexible substrate 160 is a structure that replaces a ring used to fix the high-frequency diaphragm 170, and may serve to maintain the shape of the high-frequency diaphragm 170 and the position of the high-frequency coil 150.

In addition, in order to maintain rigidity and a predetermined height, a reinforcing plate formed of a material such as film may be attached to the flexible substrate 160 separately from the circuit. In addition, a thermally fused portion electrically connected to the high-frequency coil 150 is located outside the high-frequency diaphragm 170. The position where the high-frequency coil 150 extends from the inside to the outside of the high-frequency diaphragm 170 corresponds to a portion of the flexible substrate 160, excluding the reinforcing plate, in which is recessed so as to prevent the flexible substrate 160 from being separated by the high-frequency coil 150 when attached to the underlying magnet.

The high-frequency diaphragm 170 outputs high-frequency sound in response to vibration. The high-frequency diaphragm 170 is disposed above the high-frequency coil 150 and outputs high-frequency sound in an upward direction.

The high-frequency diaphragm 170 may be a film-shaped member and may be formed of a highly elastic material. The high-frequency diaphragm 170 may be formed of a plastic film material such as PEN or PEEK, an elastomer material such as TPU, a rubber material, a metal material such as aluminum or an alloy, a graphene material, and the like.

The high-frequency diaphragm 170 may be fixed by the flexible substrate 160 having a ring structure.

Since the high-frequency coil 150 is coupled beneath the high-frequency diaphragm 170, the high-frequency diaphragm 170 may output sound upward in response to the magnetic field generated by the high-frequency coil 150. Meanwhile, a grille that functions as protection and sound outlet for the high-frequency diaphragm 170 may be disposed on the upper part of the high-frequency diaphragm 170.

In the present disclosure, by configuring the structure of a high-frequency coil in the high-frequency speaker as a plate-shaped ring structure, the size of the speaker may be minimized while maintaining the quality of the sound output.

In addition, by disposing a flexible substrate outside the high-frequency coil and positioning the high-frequency diaphragm above the flexible substrate, the size of the diaphragm may be expanded to correspond to a diameter of a speaker housing, thereby enhancing high-frequency sound performance.

The present disclosure has been described with reference to embodiments. It will be understood by those skilled in the art that various modifications may be made without departing from the essential spirit and scope of the present disclosure. Therefore, the disclosed embodiments should be considered illustrative rather than limiting. The scope of the present disclosure is defined by the claims, and all equivalents and variations falling within the scope of the claims are to be interpreted as being included in the present disclosure.

What is claimed is:

1. A high-frequency speaker for earphones, comprising:
a speaker housing;
a high-frequency yoke disposed in a lower part of the speaker housing;
a ventilation membrane disposed beneath the high-frequency yoke to adjust an amount of air ventilation;
an inner magnet disposed above a central portion of the high-frequency yoke;
an outer magnet disposed above the high-frequency yoke and disposed outside the inner magnet;
a high-frequency coil having a plate-shaped ring structure and disposed above the inner magnet and the outer magnet to extend over the inner magnet and the outer magnet;
a flexible substrate disposed outside the high-frequency coil and providing an electric signal to the high-frequency coil; and
a high-frequency diaphragm disposed above the high-frequency coil and outputting high-frequency sound.

2. The high-frequency speaker of claim 1, wherein an outer surface of the inner magnet is in close contact with a side surface of an outer magnet hole formed in the outer magnet, and the inner magnet and the outer magnet are arranged to have opposite polarities.

3. The high-frequency speaker of claim 1, wherein the high-frequency coil is in the form of a plate-shaped ring structure that is wider in a horizontal direction than in a vertical direction and is formed by winding a line conductor.

4. The high-frequency speaker of claim 1, wherein the high-frequency coil is attached to the high-frequency diaphragm and is spaced apart from upper parts of the inner magnet and the outer magnet.
